(19) United States
(12) Patent Application Publication
(10) Pub. No.: US 2025/0105407 A1
(43) Pub. Date: Mar. 27, 2025

(54) SECONDARY BATTERY

(71) Applicant: Samsung SDI Co., Ltd., Yongin-si (KR)

(72) Inventors: Eun Sung LEE, Yongin-si (KR); Dae Kyung HAN, Yongin-si (KR); Sang Dae HWANG, Yongin-si (KR)

(21) Appl. No.: 18/587,734

(22) Filed: Feb. 26, 2024

(30) Foreign Application Priority Data
Sep. 26, 2023 (KR) 10-2023-0128899

(51) Int. Cl. H01M 50/14; H01M 10/0525; H01M 10/0583; H01M 50/103; H01M 50/55; H01M 50/557

(52) U.S. Cl. CPC H01M 50/14; H01M 10/0525; H01M 10/0583; H01M 50/103; H01M 50/55; H01M 50/557

(57) ABSTRACT

A secondary battery reduces or prevents the likelihood of lifting or twisting by increasing the fixing force between an electrode plate and a separator of a stacked electrode assembly, and reduces or prevents the likelihood of damage to an electrode plate due to being pressed by a lower insulating member of a cap assembly. A secondary battery may include an electrode assembly including first and second electrode plates alternately stacked with a separator therebetween, a first current collector plate coupled to the first electrode plate, a case accommodating the electrode assembly and the first current collector plate, a cap plate coupled to the case, a first terminal contacting the first current collector plate, and having an upper end penetrating the cap plate, and an insulating tape covering upper and lower surfaces of the electrode assembly, fixing the electrode assembly, and extending along a longitudinal direction of the cap plate.

### CROSS-REFERENCE TO RELATED APPLICATION

The present application claims priority to and the benefit of Korean Patent Application No. 10-2023-0128899, filed on Sep. 26, 2023, in the Korean Intellectual Property Office, the entire disclosure of which is incorporated herein by reference.

### BACKGROUND

### 1. Field

Various embodiments of the present disclosure relate to a secondary battery.

### 2. Description of the Related Art

A secondary battery is a power storage system that converts electric energy into chemical energy, and that stores the converted energy to provide suitably high energy density. Unlike primary batteries that cannot be recharged, a secondary battery is rechargeable and is being widely used in IT devices, such as a smart phone, a cellular phone, a notebook computer, or a tablet PC. In recent years, electric vehicles are drawing attention for protection of environmental contamination, and a trend toward the use of high-capacity secondary batteries for electric vehicles is growing. The secondary battery may suitably have high density, high output, and stability characteristics.

The above information disclosed in this Background section is only for enhancement of understanding of the background of the present disclosure and therefore it may contain information that does not constitute prior art.

### SUMMARY

The present disclosure provides a secondary battery capable of reducing or preventing the likelihood of lifting or twisting by increasing the fixing force between an electrode plate and a separator of a stacked electrode assembly, and capable of reducing or preventing the likelihood of damage to an electrode plate due to being pressed by a lower insulating member of a cap assembly.

The present disclosure also provides a secondary battery in which an electrolyte can be suitably injected and impregnated into an electrode assembly through a through hole provided in an upper insulating tape.

A secondary battery according to embodiments of the present disclosure may include an electrode assembly including a first electrode plate and a second electrode plate alternately stacked with a separator therebetween, a first current collector plate coupled to the first electrode plate, a case accommodating the electrode assembly and the first current collector plate, a cap plate coupled to the case, a first terminal contacting the first current collector plate, and having an upper end penetrating the cap plate to be exposed, and an insulating tape covering an upper surface and a lower surface of the electrode assembly, fixing the electrode assembly, and extending along a longitudinal direction of the cap plate.

The insulating tape may include an upper insulating tape covering the upper surface of the electrode assembly, and covering upper portions of long side surfaces of the electrode assembly adjacent to the upper surface of the electrode assembly, and a lower insulating tape covering the lower surface of the electrode assembly, and covering lower portions of the long side surfaces adjacent to the lower surface of the electrode assembly.

An exposed area of the long side surfaces may be larger than an area in which the insulating tape is attached.

The upper insulating tape may define a through hole exposing the upper surface of the electrode assembly.

The through hole may be at a location corresponding to an injection hole penetrating the cap plate.

The secondary battery may further include a plug sealing the injection hole.

The through hole may have a diameter that is larger than a diameter of the injection hole.

The through hole may have a diameter of about 5 mm to about 15 mm.

The insulating tape may be a rectangular integrated tape, and may cover more than 80% of the upper surface of the electrode assembly.

The insulating tape may have a thickness of about 35 μm to about 55 μm.

The electrode assembly may include a first electrode uncoated portion, which is an uncoated portion of the first electrode plate, and protruding from one side, and a second electrode uncoated portion, which is an uncoated portion of the second electrode plate, and protruding from another side, wherein the separator extends in a direction perpendicular to a direction in which the first electrode uncoated portion and the second electrode uncoated portion protrude, and is bent into a “Z” shape.

The secondary battery may further include a second current collector plate contacting the second electrode uncoated portion, and a second terminal contacting the second current collector plate, and having an upper end penetrating the cap plate to be exposed.

The first terminal and the second terminal may be positioned substantially symmetrically from a longitudinal center of the cap plate.

The insulating tape may be attached to a central region of the upper surface of the electrode assembly, and a central region of the lower surface of the electrode assembly, to overlap the first terminal and the second terminal in a plan view.

The secondary battery may further include a lower insulating member between a lower surface of the cap plate and the electrode assembly.

The lower insulating member may be between the first current collector plate and the cap plate, and between the second current collector plate and the cap plate.

The lower insulating member may contact the lower surface of the cap plate, and further includes a support portion protruding toward the upper surface of the electrode assembly.

An end of the support portion may contact the insulating tape attached to the upper surface of the electrode assembly.

The first current collector plate may include a first electrode connector portion welded to the first electrode uncoated portion, and extending along one short side surface of the electrode assembly, and a first terminal connector portion including one end coupled to an upper end of the first electrode connector portion, and another end coupled to the first terminal.

The first terminal may include a first terminal plate on an upper side of the cap plate, and a first terminal pillar penetrating the cap plate, coupled to the first terminal connector portion, and coupled to the first terminal plate on the upper side of the cap plate.

### BRIEF DESCRIPTION OF DRAWINGS

FIG. 1 is a perspective view showing a secondary battery according to one or more embodiments of the present disclosure.

FIG. 2 is a perspective cross-sectional view taken along the line A-A of FIG. 1.

FIG. 3 is an enlarged view of portion B of FIG. 2.

FIG. 4 is a perspective view showing a case removed from the secondary battery of FIG. 1.

FIG. 5 is a perspective view showing an electrode assembly in the secondary battery of FIG. 1.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

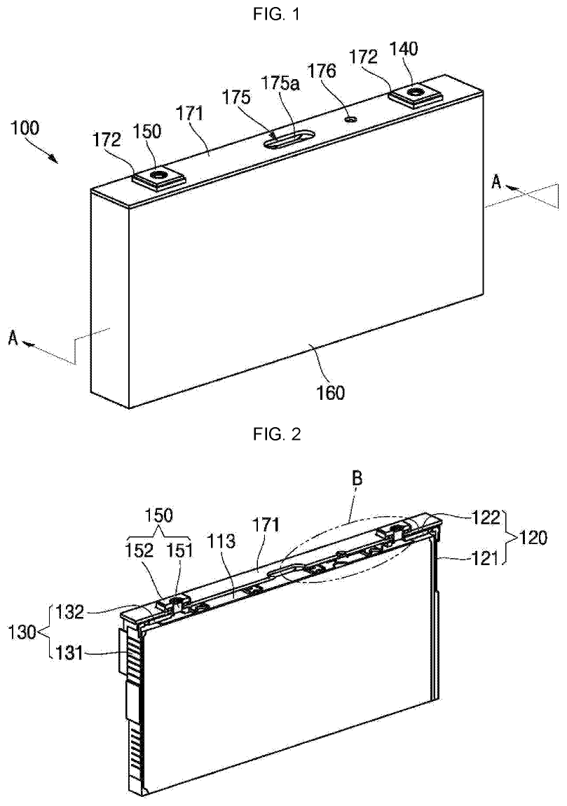

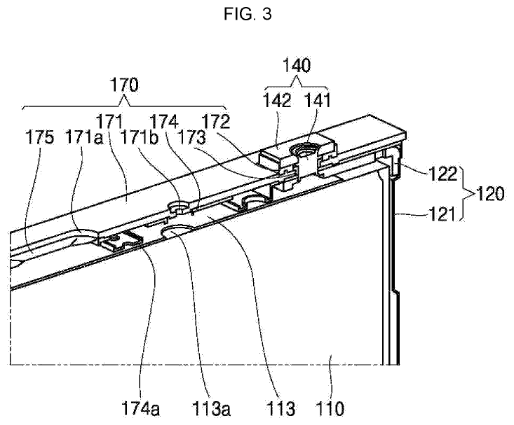

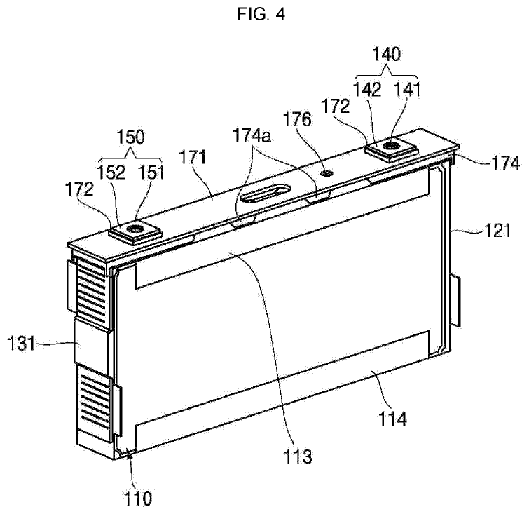

FIG. 1 is a perspective view showing a secondary battery according to one or more embodiments of the present disclosure, FIG. 2 is a perspective cross-sectional view taken along the line A-A of FIG. 1, and FIG. 3 is an enlarged view of portion B of FIG. 2. FIG. 4 is a perspective view showing a case removed from the secondary battery of FIG. 1.

As shown in FIGS. 1 to 3, the secondary battery 100 includes an electrode assembly 110, a first current collector plate 120, a second current collector plate 130, a first terminal 140, a second terminal 150, a case 160, and a cap assembly 170. Here, the first terminal 140 may include a first terminal pillar 141 and a first terminal plate 142, and the second terminal 150 may include a second terminal pillar 151 and a second terminal plate 152.

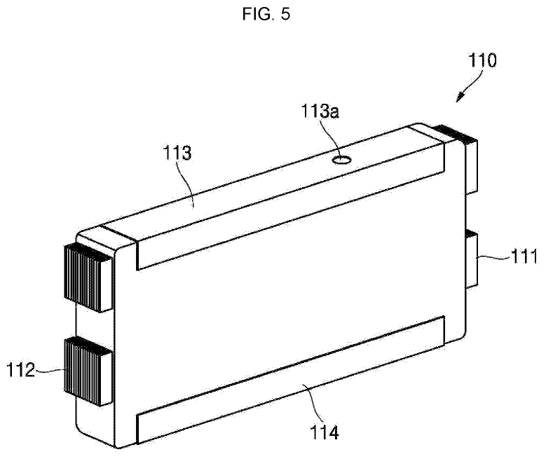

Referring to FIG. 5, a perspective view shows the electrode assembly in the secondary battery of FIG. 1. Hereinafter, the electrode assembly 110 will be described with reference to FIGS. 1 to 5.

First, the electrode assembly 110 is formed by stacking a plurality of laminates of a first electrode plate, a separator, and a second electrode plate formed in a thin plate or film shape. Here, the first electrode plate may operate as a first polarity, for example, a negative electrode, and the second electrode plate may operate as a second polarity, for example, a positive anode. In one or more embodiments, depending on the selection of a person skilled in the art, the first electrode plate and the second electrode plate may be arranged with different polarities.

The first electrode plate is formed by applying a first electrode active material, such as graphite or carbon, to a first electrode current collector formed of a metal foil, such as copper or nickel, and includes a first electrode uncoated portion 111 that is a region to which the first electrode active material is not applied. The first electrode uncoated portion 111 provides a path for current flow between the first electrode plate and the outside.

In one or more embodiments, the first electrode uncoated portion 111 overlaps at the same position if the first electrode plates are stacked, forming a multi-tap structure. The first electrode uncoated portion 111 protrudes from one short side surface of the electrode assembly 110, and in some cases, multiple first electrode uncoated portions 111 may be welded together to form one first current collection tab. In one or more embodiments, the first electrode uncoated portion 111 may include a first upper electrode uncoated portion and a first lower electrode uncoated portion to be respectively welded to the upper and lower welding regions provided on the first current collector plate 120.

The second electrode plate is formed by applying a second electrode active material, such as a transition metal oxide, to a second electrode current collector formed of a metal foil, such as aluminum, and may include a second electrode uncoated portion 112, which is a region to which the second electrode active material is not applied.

In one or more embodiments, the second electrode uncoated portion 112 also overlaps at the same position if the second electrode plates are stacked, forming a multi-tap structure. The second electrode uncoated portion 112 protrudes from the other short side surface of the electrode assembly 110, and in some cases, multiple second electrode uncoated portions 112 may be welded together to form one second current collection tab.

The separator is located between the first and second electrode plates, and serves to reduce or prevent the likelihood of short circuits, and to enable movement of lithium ions. The separator may be made of polyethylene, polypropylene, or a composite film of polyethylene and polypropylene. In one or more embodiments, the material of the separator does not limit the scope of the present disclosure. The separator may be made of one plate, and may be bent and stacked in a “Z” shape to be sandwiched between the first and second electrode plates. Here, the bent region of the separator may be located at the top and bottom sides of the electrode assembly 110.

In one or more embodiments, after the electrode assembly 110 is stacked with a plurality of electrode plates interposed between separators, the stacked state can be maintained through insulating tapes 113 and 114 attached to some regions of the outer surface. Here, the insulating tapes 113 and 114 may maintain the shape of the electrode assembly 110 to allow the electrode assembly 110 to be welded to the current collector plates 120 and 130 at correct positions, and may be fixed to maintain the structure of the electrode assembly 110, even within a final secondary battery structure.

The insulating tapes 113 and 114 may include an upper insulating tape 113 attached to the upper end of the electrode assembly 110, and a lower insulating tape 114 attached to the lower end of the electrode assembly 110. The insulating tape 113, 114 may be any tape made of an insulating material. The upper insulating tape 113 may cover the upper surface of the electrode assembly 110, and may cover a partial upper region adjacent to the upper surface on both long side surfaces. The upper insulating tape 113 may extend along the longitudinal direction of the cap plate 171. The upper insulating tape 113 may be a tape of approximately rectangular shape. The upper insulating tape 113 may be attached to approximately the center of the upper surface of the electrode assembly 110. The upper insulating tape 113 may overlap the first terminal 140 and the second terminal 150 in a plan view. The upper insulating tape 113 may cover 80% or more and 100% or less of the upper surface of the electrode assembly 110 with a single tape. If the upper insulating tape 113 is attached to cover less than 80% of the upper surface of the electrode assembly 110, the fixing force may decrease due to a decrease in the fixing area, and a lifting phenomenon of a separator may occur.

The upper insulating tape 113 may have a thickness of about 35 μm to about 55 μm. If the thickness of the upper insulating tape 113 is less than about 35 μm, it may not be easy to reduce or prevent the likelihood of pressing by the lower insulating member 174 of the cap assembly 170 to thereby secure the electrode assembly 110. If the thickness of the upper insulating tape 113 exceeds about 55 μm, the increased thickness may cause increased costs, and may cause lifting, which may lead to process defects.

The upper insulating tape 113 may be provided with a through hole 113a in a region of the cap assembly 170 that corresponds to the injection hole 171b (e.g., electrolyte injection hole). The through hole 113a may expose the upper surface of the electrode assembly 110. The through hole 113a can facilitate injection and impregnation of an electrolyte into the electrode assembly 110 if the electrolyte is injected through the injection hole 171b of the cap assembly 170. The size of the through hole 113a may be larger than the size of the injection hole 171b of the cap assembly 170. In more detail, the through hole 113a may have a diameter of about 5 mm to about 15 mm. If the diameter of the through hole 113a is smaller than about 5 mm, it may not be easy to inject the electrolyte into the electrode assembly 110, and if the diameter of the through hole 113a is larger than about 15 mm, the upper surface of the electrode assembly 110 exposed through the through hole 113a may be affected by pressure by the lower insulating member 174 of the cap assembly 170.

The upper insulating tape 113 may reduce or prevent the likelihood of lifting or twisting by increasing the fixing force between the electrode plate of the stacked electrode assembly 110 and the separator, and may reduce or prevent damage to the electrode plate due to being pressed by the lower insulating member 174 of the cap assembly 170. In one or more embodiments, by including the through hole 113a, the upper insulating tape 113 may allow an electrolyte to be suitably injected into the electrode assembly 110.

The lower insulating tape 114 may cover the lower surface of the electrode assembly 110 and a partial upper region adjacent to the lower surface on both long side surfaces. The lower insulating tape 114 may be a tape of approximately rectangular shape. The lower insulating tape 114 may be attached to approximately the center of the lower surface of the electrode assembly 110. The lower insulating tape 114 may be similar in thickness and size to the upper insulating tape 113.

Because the insulating tapes 113 and 114 include the upper insulating tape 113 and the lower insulating tape 114, the long side surface of the electrode assembly 110 may be exposed to the outside. The exposed area of both long side surfaces of the electrode assembly 110 may be larger than the area in which the insulating tapes 113 and 114 are attached. Attaching the insulating tapes 113 and 114 to cover the entire long side surfaces of the electrode assembly 110 may merely unnecessarily increase the thickness of the electrode assembly 110, and thus, compared to the same volume, the capacity of the electrode assembly 110 may be decreased.

The electrode assembly 110 is substantially accommodated in the case 160 together with an electrolyte. The electrolyte may include an organic solvent, such as ethylene carbonate (EC), propylene carbonate (PC), diethyl carbonate (DEC), ethyl methyl carbonate (EMC), or dimethyl carbonate (DMC), and a lithium salt, such as LiPF6 or LiBF4. In one or more embodiments, the electrolyte may be in a liquid or gel phase.

The first current collector plate 120 is made of a conductive material, such as nickel, and is electrically connected to the first electrode plate by being coupled to the first electrode uncoated portion 111 protruding from the short side surface of the electrode assembly 110. The first current collector plate 120 may be electrically connected to the first electrode uncoated portion 111 by welding. The first current collector plate 120 may include a first electrode connector portion 121 extending vertically along one short side surface of the electrode assembly 110, and a first terminal connector portion 122 interposed between the electrode assembly 110 and the cap plate 171, and coupled to the first terminal 140.

The first electrode connector portion 121 extends vertically along one side of the electrode assembly 110, and may have a substantially plate shape. The first electrode connector portion 121 is coupled through welding in a state of being in contact with the first electrode uncoated portion 111 of the electrode assembly 110, and may have a first polarity, like the first electrode uncoated portion 111.

The first terminal connector portion 122 is formed in an approximately “L” shape, may have an approximately plate shape, and may include an upper portion interposed between the cap plate 171 and the electrode assembly 110, and a side portion bent to extend downwardly from an outer end of the upper portion. Here, the side portion may extend in a vertical direction along one short side surface of the electrode assembly 110. The upper portion of the first terminal connector portion 122 may be positioned parallel to the cap plate 171, and may have a terminal hole penetrating between the upper and lower surfaces. The first terminal pillar 141 may be inserted into the terminal hole to be riveted and/or welded.

The side portion of the first terminal connector portion 122 may be electrically and mechanically coupled to the top end of the first electrode connector portion 121 by welding. The first terminal connector portion 122 is coupled to the first electrode connector portion 121 by welding, for example, laser welding, to form the first current collector plate 120.

The second current collector plate 130 is made of a conductive material, such as aluminum, and is in contact with the second electrode uncoated portion 112 protruding from the other short side surface of the electrode assembly 110 to be electrically connected to the second electrode plate. The second current collector plate 130 includes a second electrode connector portion 131 and a second terminal connector portion 132. Because the shape of the second current collector plate 130 is substantially the same as that of the first current collector plate 120, duplicate descriptions will be omitted.

The first terminal 140 is made of a conductive material, such as nickel, and may be electrically connected to the first current collector plate 120. The first terminal 140 includes a first terminal pillar 141 and a first terminal plate 142. The first terminal pillar 141 may be coupled to the first terminal plate 142 on the upper side of the cap plate 171.

The first terminal pillar 141 may penetrate the cap plate 171, and may be electrically connected to the first current collector plate 120 at the lower part of the cap plate 171. The lower portion of the first terminal pillar 141 may be inserted into the terminal hole of the first current collector plate 120 and then riveted and/or welded.

The second terminal 150 is made of a conductive aluminum material, and is electrically connected to the second current collector plate 130. The second terminal 150 includes a second terminal pillar 151 and a second terminal plate 152. The second terminal 150 may be positioned symmetrically with the first terminal 140 from the longitudinal center of the cap plate 171. For example, with the safety vent 175 as the center, the first terminal 140 and the second terminal 150 may be positioned to be—substantially symmetrical to each other. Because the shape of the second terminal 150 is the same as that of the first terminal 140, redundant descriptions will be omitted.

The case 160 is made of a conductive metal, such as aluminum, an aluminum alloy, or nickel-plated steel, and the electrode assembly 110, first current collector plate 120, and has an approximately hexahedral shape with an opening into which the electrode assembly 110, the first current collector plate 120, and the second current collector plate 130 can be inserted and seated. A cap plate 171 may be coupled to the opening of the case 160 to seal the case 160. The inner surface of the case 160 is insulated, thereby reducing or preventing the likelihood of electrical short circuits occurring inside.

The cap assembly 170 may be coupled to the opening of case 160. The cap assembly 170 may include a cap plate 171, an upper coupling member 172, a seal gasket 173, a lower insulating member 174, a safety vent 175, and a plug 176.

The cap plate 171 may seal the opening 161 of the case 160. The cap plate 171 may include a vent hole 171a and an injection hole 171b penetrating between the upper and lower surfaces. Here, the vent hole 171a may be located approximately at the center of the cap plate 171. In one or more embodiments, the injection hole 171b may be positioned to be spaced apart from the vent hole 171a in one direction. The through hole 113a of the upper insulating tape 113 may be located below the injection hole 171b. In one or more embodiments, the injection hole 171b and the through hole 113a may overlap on a plane.

The upper coupling member 172 may be formed between the cap plate 171 and the first and second terminal plates 142 and 152 at the top of the cap plate 171. In one or more embodiments, the upper coupling member 172 is in close contact with the cap plate 171. Moreover, the upper coupling member 172 may also be in close contact with the seal gasket 173. The upper coupling member 172 may insulate the first terminal plate 142 and the second terminal plate 152 from the cap plate 171. In some examples, the upper coupling member 172 interposed between the second terminal plate 152 and the cap plate 171 may electrically connect the second terminal plate 152 and the cap plate 171. In one or more embodiments, the cap plate 171 may have the same polarity as the second terminal 150. In this case, the case 160 may also have the same polarity as the cap plate 171, and the likelihood of electrical shorting with the electrode assembly 110 is reduced or prevented by internal insulation.

The seal gasket 173 is made of an insulating material, and may be formed in plurality between the cap plate 171 and the first terminal pillar 141 of the first terminal 140, and between the cap plate 171 and the second terminal pillar 151 of the second terminal 150, respectively. The seal gasket(s) 173 seals a portion between the first terminal pillar 141 and the cap plate 171, and between the second terminal pillar 151 and the cap plate 171. The seal gasket 173 reduces or prevents external moisture from penetrating into the interior of the secondary battery 100, or reduces or prevents the likelihood of electrolyte contained within the secondary battery 100 leaking out.

The lower insulating member 174 may be interposed between the cap plate 171 and the electrode assembly 110. The lower insulating member 174 may also be interposed between the cap plate 171 and the first terminal connector portion 122 of the first current collector plate 120, and between the cap plate 171 and the second terminal connector portion 132 of the second current collector plate 130. In one or more embodiments, the lower insulating member 174 may be interposed between the cap plate 171 and the electrode assembly 110 in the central area of the cap plate 171, and may be interposed between the cap plate 171 and the first terminal connector portion 122, and between the cap plate 171 and the second terminal connector portion 132, in the edge area(s) of the cap plate 171.

The lower insulating member 174 may be made of an insulating material, and may reduce or prevent the likelihood of the electrode assembly 110 and the cap plate 171 being in electrical contact with each other. In one or more embodiments, the lower insulating member 174 may reduce or prevent electrical contacts between the cap plate 171 and the first current collector plate 120, and between the cap plate 171 and the second current collector plate 130.

The upper surface of the lower insulating member 174 may be in close contact with the lower surface of the cap plate 171. The lower insulating member 174 may include a support portion 174a that protrudes in a downward direction toward the electrode assembly 110. The end of the support portion 174a may be in contact with the upper surface of the electrode assembly 110. The electrode assembly 110 has an upper insulating tape 113 attached to the upper surface, which can reduce or prevent the likelihood of the electrode assembly 110 being damaged by being pressed by the support portion 174a.

The support portion 174a may maintain the gap between the cap plate 171 and the electrode assembly 110. In one or more embodiments, the support portion 174a may reduce or prevent the likelihood of the electrode assembly 110 flowing or moving in the up or down directions inside the case 160. The support portion(s) 174a may be located between the first terminal 140 and the safety vent 175, and between the second terminal 150 and the safety vent 175, in a plan view. In one or more embodiments, the support portion 174a may not overlap the injection hole 171b on a plane.

The lower insulating member 174 may be interposed between the case 160 and the first terminal connector portion 122 of the first current collector plate 120, and between the second terminal connector portion 132 of the case 160 and the second current collector plate 130. In one or more embodiments, in the lower insulating member 174, the upper surface may be interposed between the cap plate 171 and the electrode assembly 110, and some areas on respective sides where the first terminal connector portion 122 and the second terminal connector portion 132 are located may extend downwardly from the upper surface. The lower insulating member 174 may reduce or prevent contacts between the first terminal connector portion 122 and the case 160, and between the second terminal connector portion 132 and the case 160.

The safety vent 175 may be installed in the vent hole 171a of the cap plate 171, and a notch 175a may be formed so as to be opened at a corresponding pressure (e.g., set pressure). The plug 176 may seal the injection hole 171b after the electrolyte is injected into the interior of the case 160 through the injection hole 171b.

As described above, the secondary battery according to various embodiments of the present disclosure is capable of reducing or preventing the likelihood of lifting or twisting by increasing the fixing force between an electrode plate and a separator of a stacked electrode assembly, and capable of reducing or preventing the likelihood of damage to an electrode plate due to being pressed by a lower insulating member of a cap assembly.

In one or more embodiments, in the secondary battery according to various embodiments of the present disclosure, an electrolyte can be suitably injected and impregnated into an electrode assembly through a through hole provided in an upper insulating tape.

While the foregoing describes embodiments for carrying out the secondary battery according to the present disclosure, which is not limited to any one embodiment, it will be understood by a person skilled in the art that various changes in form and details may be made therein without departing from the spirit and scope of the present disclosure as defined by the following claims, with functional equivalents thereof to be included therein.

What is claimed is:

1. A secondary battery comprising:
an electrode assembly comprising a first electrode plate and a second electrode plate alternately stacked with a separator therebetween;
a first current collector plate coupled to the first electrode plate;
a case accommodating the electrode assembly and the first current collector plate;
a cap plate coupled to the case;
a first terminal contacting the first current collector plate, and having an upper end penetrating the cap plate to be exposed; and
an insulating tape covering an upper surface and a lower surface of the electrode assembly, fixing the electrode assembly, and extending along a longitudinal direction of the cap plate.

2. The secondary battery as claimed in claim 1, wherein the insulating tape comprises:
an upper insulating tape covering the upper surface of the electrode assembly, and covering upper portions of long side surfaces of the electrode assembly adjacent to the upper surface of the electrode assembly; and
a lower insulating tape covering the lower surface of the electrode assembly, and covering lower portions of the long side surfaces adjacent to the lower surface of the electrode assembly.

3. The secondary battery as claimed in claim 2, wherein an exposed area of the long side surfaces is larger than an area in which the insulating tape is attached.

4. The secondary battery as claimed in claim 2, wherein the upper insulating tape defines a through hole exposing the upper surface of the electrode assembly.

5. The secondary battery as claimed in claim 4, wherein the through hole is at a location corresponding to an injection hole penetrating the cap plate.

6. The secondary battery as claimed in claim 5, further comprising a plug sealing the injection hole.

7. The secondary battery as claimed in claim 5, wherein the through hole has a diameter that is larger than a diameter of the injection hole.

8. The secondary battery as claimed in claim 4, wherein the through hole has a diameter of about 5 mm to about 15 mm.

9. The secondary battery as claimed in claim 1, wherein the insulating tape is a rectangular integrated tape, and covers more than 80% of the upper surface of the electrode assembly.

10. The secondary battery as claimed in claim 1, wherein the insulating tape has a thickness of about 35 μm to about 55 μm.

11. The secondary battery as claimed in claim 1, wherein the electrode assembly comprises:
a first electrode uncoated portion, which is an uncoated portion of the first electrode plate, and protruding from one side; and
a second electrode uncoated portion, which is an uncoated portion of the second electrode plate, and protruding from another side, and
wherein the separator extends in a direction perpendicular to a direction in which the first electrode uncoated portion and the second electrode uncoated portion protrude, and is bent into a “Z” shape.

12. The secondary battery as claimed in claim 11, further comprising:
a second current collector plate contacting the second electrode uncoated portion; and
a second terminal contacting the second current collector plate, and having an upper end penetrating the cap plate to be exposed.

13. The secondary battery as claimed in claim 12, wherein the first terminal and the second terminal are positioned substantially symmetrically from a longitudinal center of the cap plate.

14. The secondary battery as claimed in claim 12, wherein the insulating tape is attached to a central region of the upper surface of the electrode assembly, and a central region of the lower surface of the electrode assembly, to overlap the first terminal and the second terminal in a plan view.

15. The secondary battery as claimed in claim 12, further comprising a lower insulating member between a lower surface of the cap plate and the electrode assembly.

16. The secondary battery as claimed in claim 15, wherein the lower insulating member is between the first current collector plate and the cap plate, and between the second current collector plate and the cap plate.

17. The secondary battery as claimed in claim 15, wherein the lower insulating member contacts the lower surface of the cap plate, and further comprises a support portion protruding toward the upper surface of the electrode assembly.

18. The secondary battery as claimed in claim 17, wherein an end of the support portion contacts the insulating tape attached to the upper surface of the electrode assembly.

19. The secondary battery as claimed in claim 11, wherein the first current collector plate comprises:
a first electrode connector portion welded to the first electrode uncoated portion, and extending along one short side surface of the electrode assembly; and
a first terminal connector portion comprising one end coupled to an upper end of the first electrode connector portion, and another end coupled to the first terminal.

20. The secondary battery as claimed in claim 19, wherein the first terminal comprises:
a first terminal plate on an upper side of the cap plate; and
a first terminal pillar penetrating the cap plate, coupled to the first terminal connector portion, and coupled to the first terminal plate on the upper side of the cap plate.
